(19) United States
(12) Patent Application Publication
(10) Pub. No.: US 2025/0219060 A1
(43) Pub. Date: Jul. 3, 2025

(54) POSITIVE ELECTRODE COMPOSITE ACTIVE MATERIAL AND METHOD FOR PRODUCING POSITIVE ELECTRODE COMPOSITE ACTIVE MATERIAL

(71) Applicant: KANEKA CORPORATION, Osaka-shi, Osaka (JP)

(72) Inventors: Junichi IMAIZUMI, Settsu-shi (JP); Takashi KIKUCHI, Settsu-shi (JP); Mitsuyasu IMAZAKI, Settsu-shi (JP)

(21) Appl. No.: 18/836,262

(22) PCT Filed: Jan. 27, 2023
(86) PCT No.: PCT/JP2023/002566

§ 371 Date: Mar. 17, 2025

(30) Foreign Application Priority Data
Feb. 7, 2022 (JP) 2022-017263

(51) Int. Cl. H01M 4/36; H01M 4/02; H01M 4/04; H01M 4/505; H01M 4/58; H01M 10/0525

(52) U.S. Cl. CPC H01M 4/366; H01M 4/0471; H01M 4/505; H01M 4/5825; H01M 10/0525; H01M 2004/021; H01M 2004/028

(57) ABSTRACT

The present invention provides a positive electrode composite active substance which includes a uniform coating layer as compared with the related art and can suppress generation of gas due to decomposition of a nonaqueous electrolytic solution, and a method of manufacturing the positive electrode composite active substance. An oxide active substance, and a coating layer covering a surface of the oxide active substance are provided, the oxide active substance includes a lithium manganese-based oxide having a spinel-type crystal structure, the coating layer includes a phosphate-based compound represented by Formula (1), and the coating layer has a thickness of 5 nm or more and 20 nm or less,

LiₐA_{b}D_{c}PO₄ (1)
where a, b, and c satisfy 0.9<a<1.1, 0<b≤1, 0≤c<1, 0.9<b+c<1.1, A is at least one selected from the group consisting of Co, Mn, Ni, Fe, Cu, and Cr, and D is at least one selected from the group consisting of Mg, Ca, Sr, Ba, Ti, Zn, B, Al, Ga, In, Si, Ge, Sc, and Y.

### TECHNICAL FIELD

The present invention relates to a positive electrode composite active substance and a method of manufacturing a positive electrode composite active substance.

### BACKGROUND ART

Conventionally, lithium ion secondary batteries have attracted attention as applications such as in-vehicle power supplies for electric vehicles, and further increase in energy density is required.

Examples of the positive electrode active substance of the lithium ion secondary battery include lithium nickel manganese oxide (hereinafter, also referred to as LNMO)(for example, Patent Document 1).

LNMO has an operating voltage of 4.7 V based on a lithium deposition potential, which is higher than that of a conventional lithium insertion material (for example, lithium cobaltate is 4 V) used as a positive electrode active substance material, and is expected for high energy density.

### PRIOR ART DOCUMENTS

### Patent Documents

Patent Document 1: JP 2021-051987 A
Patent Document 2: WO 2020/049843 A

### DISCLOSURE OF INVENTION

### Technical Problem

However, since LNMO has a high operating voltage and the reaction proceeds in an oxidizing atmosphere, there is a problem in which a portion of a nonaqueous electrolytic solution is decomposed and gas is generated.

Therefore, in Patent Document 2, by coating a surface of the LNMO with LATP, the LNMO is not directly exposed to the nonaqueous electrolytic solution, and a generation amount of gas can be suppressed.

However, as a result of studying the secondary battery of Patent Document 2, since the nanoparticles aggregate on the surface of LNMO to form a coating layer when the coating layer is formed, there is a problem in which a portion having a locally different thickness is generated and a stable uniform coating layer is hardly formed.

Therefore, an object of the present invention is to provide a positive electrode composite active substance which includes a uniform coating layer as compared with the related art and can suppress generation of gas due to decomposition of a nonaqueous electrolytic solution, and a method of manufacturing the positive electrode composite active substance.

### Solution to Problem

One aspect of the present invention for solving the above-described problems is a positive electrode composite active substance constituting a part of a positive electrode of a lithium ion secondary battery using a nonaqueous electrolytic solution as an electrolyte, the positive electrode composite active substance including: an oxide active substance; and a coating layer covering a surface of the oxide active substance, in which the oxide active substance includes a lithium manganese-based oxide having a spinel-type crystal structure, the coating layer includes a phosphate-based compound represented by Formula (1) described below, and the coating layer has a thickness of 5 nm or more and 20 nm or less,

LiₐA_{b}D_{c}PO₄ (1)
where a, b, and c satisfy 0.9<a<1.1, 0<b≤1, 0≤c<1, 0.9<b+c<1.1, A is at least one selected from the group consisting of Co, Mn, Ni, Fe, Cu, and Cr, and D is at least one selected from the group consisting of Mg, Ca, Sr, Ba, Ti, Zn, B, Al, Ga, In, Si, Ge, Sc, and Y.

Here, the “thickness of the coating layer” can be determined, for example, by directly observing the coating layer with a microscope such as a transmission electron microscope (TEM) or a scanning electron microscope (SEM), and arithmetically averaging thicknesses at three or more specific measurement points separated by 10 nm or more.

According to this aspect, the surface of the oxide active substance including the lithium manganese-based oxide having the spinel-type crystal structure is covered with the coating layer including the phosphate-based compound satisfying Formula (1) described above. As a result, it is possible to suppress the contact of the oxide active substance with the nonaqueous electrolytic solution and to alleviate dielectric polarization on the surface as compared with the conventional case, so that it is possible to suppress the generation of gas due to the decomposition of the nonaqueous electrolytic solution.

According to this aspect, since the coating layer including the phosphate-based compound satisfying Formula (1) described above is provided, the coating layer tends to be a uniform layer as compared with the related art.

According to this aspect, generation of gas can be suppressed even when the thickness of the coating layer is thin, and resistance loss due to the phosphate-based compound can be suppressed.

In a preferred aspect, the coating layer is amorphous in a range of 2 nm from an interface with the oxide active substance.

The term “amorphous” as used herein refers to a state where lattice fringes regularly arranged are invisible when observed with a transmission electron microscope at a magnification of 500,000 times.

According to this aspect, since the vicinity of the interface of the coating layer with the oxide active substance is amorphous, interface resistance between the oxide active substance and the coating layer can be reduced.

In a preferred aspect, the oxide active substance is a compound represented by Formula (2) described below,

Li₁₊ₓM_{y}Mn_{2-x-y}O₄ (2)

where x and y satisfy 0≤x≤0.2 and 0<y≤0.8, respectively, and M is at least one selected from the group consisting of Al, Mg, Zn, Ni, Co, Fe, Ti, Cu, and Cr.

One aspect of the present invention is a method of manufacturing a positive electrode composite active substance that constitutes a portion of a positive electrode of a lithium ion secondary battery using a nonaqueous electrolytic solution as an electrolyte, and includes an oxide active substance and a coating layer covering a surface of the oxide active substance, the method comprising: a fine particle fluid forming step of dispersing phosphate-based compound particles in a dispersion solvent to form a fine particle fluid; a ground product forming step of grinding the fine particle fluid into an oxide active substance to form a ground product; and a removal step of subjecting the ground product to a heat treatment and removing the dispersion solvent to form the coating layer, in which the phosphate-based compound particles have an average particle size larger than or equal to a thickness of the coating layer, and include a phosphate-based compound represented by Formula (1) described below,

LiₐA_{b}D_{c}PO₄ (1)

where a, b, and c satisfy 0.9<a<1.1, 0<b≤1, 0≤c<1, 0.9<b+c<1.1, A is at least one selected from the group consisting of Co, Mn, Ni, Fe, Cu, and Cr, and D is at least one selected from the group consisting of Mg, Ca, Sr, Ba, Ti, Zn, B, Al, Ga, In, Si, Ge, Sc, and Y.

The “average particle size” as used herein represents an arithmetic average particle size, and can be determined by various methods. For example, the “average particle size” may be directly observed using a microscope such as a transmission electron microscope (TEM) or a scanning electron microscope (SEM) and determined by the arithmetic average diameter, may be determined by calculating from the specific surface area by a specific surface area measurement method (BET method), or may be determined by measuring by an X-ray diffraction method (XRD), a dynamic light scattering method (DLS), a laser diffraction/scattering method (LD), or the like. The same applies hereinafter.

According to this aspect, it is possible to manufacture a positive electrode composite active substance which can form a high-quality and thin coating layer on the surface of the oxide active substance and can suppress the generation of gas due to the decomposition of the nonaqueous electrolytic solution as compared with the conventional case.

In a preferred aspect, the method includes a pulverization step of pulverizing a phosphate-based compound having an olivine type crystal structure to form the phosphate-based compound particles before the fine particle fluid forming step.

According to this aspect, it is easy to make the phosphate-based compound particles amorphous.

In a preferred aspect, the phosphate-based compound particles have an average particle size of 30 nm or more and 500 nm or less.

In a preferred aspect, the coating layer has a thickness of 5 nm or more and 20 nm or less.

In a preferred aspect, the ground product is heat-treated at a temperature of 100° C. or more and 500° C. or less to remove the dispersion solvent.

### Effect of Invention

According to the positive electrode composite active substance of the present invention, a uniform coating layer is provided as compared with the conventional case, and generation of gas due to decomposition of the nonaqueous electrolytic solution can be suppressed.

According to the method of manufacturing a positive electrode composite active substance of the present invention, it is possible to manufacture a positive electrode composite active substance capable of forming a coating layer having high quality and a thin thickness on the surface of the oxide active substance, and capable of suppressing the generation of gas due to the decomposition of the nonaqueous electrolytic solution as compared with the conventional case.

### BRIEF DESCRIPTION OF DRAWINGS

FIG. 1 is a cross-sectional view conceptually illustrating a lithium ion secondary battery according to a first embodiment of the present invention.

FIG. 2 is a scanning transmission electron microscope image of Example 1 of the present invention, in which FIG. 2A represents the vicinity of an interface between an oxide active substance and a coating layer, and FIG. 2B represents an enlarged view of an A region in FIG. 2A.

FIG. 3 is a scanning transmission electron microscope image of Comparative Example 1 of the present invention.

### BEST MODE FOR CARRYING OUT THE INVENTION

Hereinafter, embodiments of the present invention will be described in detail.

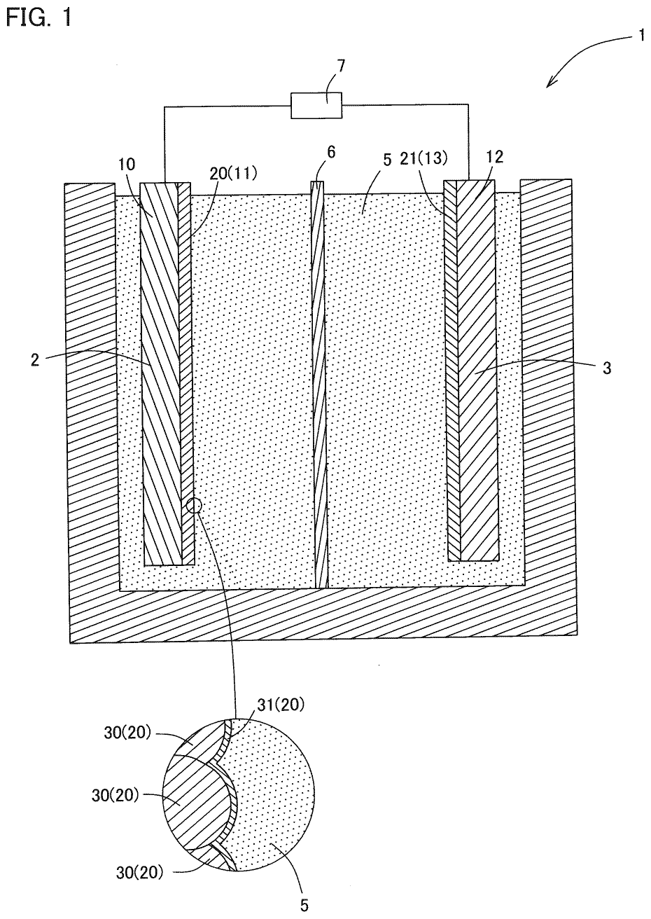

As illustrated in FIG. 1, a lithium ion secondary battery 1 of a first embodiment of the present invention includes a positive electrode 2, a negative electrode 3, a nonaqueous electrolytic solution 5, and a separator 6, and an external load 7 is connected to the positive electrode 2 and the negative electrode 3.

The positive electrode 2 is formed by laminating a positive electrode composite active substance layer 11 on a positive electrode current collector 10, and is an intercalation electrode capable of inserting and desorbing lithium ions.

The positive electrode composite active substance layer 11 includes a positive electrode composite active substance 20, a conductive aid, and a binder.

The negative electrode 3 is formed by laminating a negative electrode active substance layer 13 on a negative electrode current collector 12, and is an intercalation electrode capable of inserting and desorbing lithium ions.

The negative electrode active substance layer 13 includes a negative electrode active substance 21, a conductive aid, and a binder.

The positive electrode composite active substance 20 is a coated positive electrode active substance in which a surface of an oxide active substance 30 is coated with a coating layer 31.

### <Oxide Active Substance 30>

The oxide active substance 30 is a lithium ion conductive active substance, and an average potential of lithium desorption and lithium insertion is preferably 4.5 V or more and 5.0 V or less with respect to a Li deposition potential (Also indicated as vs. Li⁺/Li). That is, the oxide active substance 30 preferably has an operation potential of 4.5 V or more and 5.0 V or less based on lithium metal as a single body.

The potential (hereinafter, also referred to as a voltage) (vs. Li⁺/Li) of the lithium ion insertion and desorption reaction can be obtained, for example, by measuring charge/discharge characteristics of an operating electrode using the oxide active substance 30 and a half battery using lithium metal as a counter electrode, and reading voltage values at the start and end of plateau. In a case where there are two or more plateaus, the plateau of the lowest voltage value may be 4.5 V (vs. Li⁺/Li) or more, and the plateau of the highest voltage value may be 5.0 V (vs. Li⁺/Li) or less.

The oxide active substance 30 is not particularly limited, but is preferably a spinel-type lithium manganese-based oxide represented by Formula (1) described below,

Li₁₊ₓM_{y}Mn_{2-x-y}O₄ (1)

where x and y satisfy 0≤x≤0.2 and 0<y≤0.8, respectively, and M is at least one selected from the group consisting of Al, Mg, Zn, Ni, Co, Fe, Ti, Cu, and Cr.

In Formula (1) described above, a Ni-substituted lithium manganese compound (LNMO) in which M is Ni is preferable, and in particular, x=0, y=0.5, and M=Ni are preferable, that is, LiNi_{0.5}Mn_{1.5}O₄ is particularly preferable because it has a high charge/discharge cycle stability effect.

A particle size of the oxide active substance 30 is not particularly limited, but a median diameter d50 is preferably 5 μm or more, more preferably 10 μm or more, and still more preferably 20 μm or more.

Within this range, a difference from a particle size of the coating layer 31 can be secured, and the coating of the coating layer 31 becomes easy.

Furthermore, in the oxide active substance 30, the median diameter d50 is preferably 100 μm or less, more preferably 80 μm or less, still more preferably 50 μm or less, and particularly preferably 30 μm or less.

### <Coating Layer 31>

The coating layer 31 is composed of a lithium ion conductive oxide containing phosphorus as an element, and is preferably composed of an intercalation material that alone functions as a positive electrode active substance.

The lithium ion conductive oxide used in the coating layer 31 of the present embodiment is a lithium phosphate-based lithium ion conductive oxide represented by Formula (1) described below,

LiₐA_{b}D_{c}PO₄ (1)

where a, b, and c satisfy 0.9<a<1.1, 0<b≤1, 0≤c<1, 0.9<b+c<1.1, A is at least one selected from the group consisting of Co, Mn, Ni, Fe, Cu, and Cr, and D is at least one selected from the group consisting of Mg, Ca, Sr, Ba, Ti, Zn, B, Al, Ga, In, Si, Ge, Sc, and Y.

The lithium ion conductive oxide constituting the coating layer 31 preferably has an average particle size of 30 nm or more and 500 nm or less as calculated using an X-ray small angle scattering method.

A median diameter d50 of the oxide active substance 30 is preferably 100 or more and 10,000 or less, more preferably 300 or more and 5,000 or less, still more preferably 500 or more and 2,000 or less, and particularly preferably 1,000 or less when the average particle size of the lithium ion conductive oxide constituting the coating layer 31 is 1.

Within this range, the coating of the oxide active substance 30 with the lithium ion conductive oxide is more dominant than the aggregation of the lithium ion conductive oxides or the formation of aggregates of the oxide active substance 30 and the lithium ion conductive oxide, and the lithium ion conductive oxide can easily coat the surface of the oxide active substance 30 to form the coating layer 31.

An amount of the coating layer 31 is preferably 0.5 parts by mass or more, more preferably 1 part by mass or more, and still more preferably 2 parts by mass or more with respect to 100 parts by mass of the oxide active substance 30.

Furthermore, the amount of the coating layer 31 is preferably 10 parts by mass or less, more preferably 5 parts by mass or less, and still more preferably 4 parts by mass or less with respect to 100 parts by mass of the oxide active substance 30.

The coating layer 31 constitutes a continuous layer that closely covers the surface shape of the oxide active substance 30.

A thickness of the coating layer 31 is thinner than the average particle size of the lithium ion conductive oxide, and is preferably 20 nm or less, and more preferably 15 nm or less.

The thickness of the coating layer 31 is preferably 5 nm or more.

Within this range, it is possible to suppress the gas generation amount while suppressing the resistance loss in the coating layer 31.

The coating layer 31 is preferably amorphous in a range of 2 nm from an interface with the oxide active substance 30 from the viewpoint of reducing the interface resistance between the oxide active substance 30 and the coating layer 31.

In the coating layer 31, 90% or more of the region is preferably amorphous, and 95% or more of the region is preferably amorphous.

### <Negative Electrode Active Substance 21>

As the negative electrode active substance 21, lithium titanate is preferably used from the viewpoint of hardly causing lithium deposition and improving safety.

Among the lithium titanate, the negative electrode active substance 21 is particularly preferably lithium titanate having a spinel structure from the viewpoint of small expansion and contraction of the active substance in the reaction of insertion and desorption of lithium ions.

The lithium titanate may contain a trace amount of elements other than lithium and titanium, such as Nb, for example.

### <Conductive Aid>

The conductive aid is not particularly limited, but a carbon material is preferable.

The carbon material is preferably at least one selected from natural graphite, artificial graphite, vapor grown carbon fiber, carbon nanotube, acetylene black, ketjen black, and furnace black.

An amount of the conductive aid contained in the positive electrode 2 is preferably 1 part by weight or more and 30 parts by weight or less with respect to 100 parts by weight of the positive electrode composite active substance 20.

An amount of the conductive aid contained in the negative electrode 3 is preferably 1 part by weight or more and 30 parts by weight or less with respect to 100 parts by weight of the negative electrode active substance 21.

Within the above range, the adhesiveness with the binder is maintained while the conductivity of the electrodes 2 and 3 is secured, and the adhesiveness with the current collectors 10 and 12 can be sufficiently obtained.

### <Binder>

The binder is not particularly limited, but for both the positive electrode 2 and the negative electrode 3, for example, at least one selected from the group consisting of polyvinylidene fluoride (PVdF), polytetrafluoroethylene (PTFE), styrene-butadiene rubber, polyimide, and derivatives thereof can be used.

The binder is preferably dissolved or dispersed in a nonaqueous solvent or water from the viewpoint of ease of preparation of the positive electrode 2 and the negative electrode 3.

The nonaqueous solvent is not particularly limited, and examples thereof include N-methyl-2-pyrrolidone (NMP), dimethylformamide, dimethylacetamide, methyl ethyl ketone, methyl acetate, ethyl acetate, and tetrahydrofuran. A dispersant and a thickener may be added thereto.

An amount of the binder contained in the positive electrode 2 is preferably 1 part by weight or more and 30 parts by weight or less with respect to 100 parts by weight of the positive electrode composite active substance 20.

An amount of the binder contained in the negative electrode 3 is preferably 1 part by weight or more and 30 parts by weight or less with respect to 100 parts by weight of the negative electrode active substance 21.

Within the above range, the adhesiveness between the active substances 20 and 21 and the conductive aid material is maintained, and the adhesiveness with the current collectors 10 and 12 can be sufficiently obtained.

### <Current Collectors 10 and 12>

The current collectors 10 and 12 are not particularly limited, but are preferably aluminum or an aluminum alloy since they are stable under a positive electrode reaction atmosphere and a negative electrode reaction atmosphere, and are more preferably high-purity aluminum represented by JIS standards 1030, 1050, 1085, 1N90, 1N99, and the like.

As the current collectors 10 and 12, it is also possible to use those in which a surface of a metal other than aluminum (copper, SUS, nickel, titanium, and alloys thereof) is coated with a metal that does not react at the potential of the positive electrode 2 and the negative electrode 3.

### <Nonaqueous Electrolytic Solution 5>

The nonaqueous electrolytic solution 5 is not particularly limited, but a nonaqueous electrolytic solution in which a solute is dissolved in a nonaqueous solvent, a gel electrolyte in which a polymer is impregnated with a nonaqueous electrolytic solution in which a solute is dissolved in a nonaqueous solvent, or the like can be used.

The nonaqueous solvent preferably contains a cyclic aprotic solvent and/or a chain aprotic solvent.

Examples of the cyclic aprotic solvent include cyclic carbonate, cyclic ester, cyclic sulfone, and cyclic ether.

As the chain aprotic solvent, a solvent generally used as a solvent of a nonaqueous electrolyte, such as a chain carbonate, a chain carboxylic acid ester, a chain ether, or acetonitrile, may be used.

More specifically, as the aprotic solvent, dimethyl carbonate, methyl ethyl carbonate, diethyl carbonate, dipropyl carbonate, methyl propyl carbonate, ethylene carbonate, propylene carbonate, butylene carbonate, γ-butyllactone, 1,2-dimethoxyethane, sulfolane, dioxolane, methyl propionate, and the like can be used.

These solvents may be used singly or in combination of two or more kinds thereof, but it is preferable to use a mixture of two or more kinds thereof from the viewpoint of improvement of solubility of solute described later and high lithium ion conductivity.

In a case where two or more kinds are mixed as the aprotic solvent, one or more kinds among chain carbonates exemplified by dimethyl carbonate, methylethyl carbonate, diethyl carbonate, dipropyl carbonate, and methylpropyl carbonate and one or more kinds among cyclic compounds exemplified by ethylene carbonate, propylene carbonate, butylene carbonate, and γ-butyllactone are preferably mixed because of high stability at high temperatures and high lithium conductivity at low temperatures.

It is particularly preferable to mix one or more of chain carbonates exemplified by dimethyl carbonate, methylethyl carbonate, and diethyl carbonate with one or more of cyclic carbonates exemplified by ethylene carbonate, propylene carbonate, and butylene carbonate.

The solute used in the nonaqueous electrolytic solution 5 is not particularly limited, but for example, LiClO₄, LiBF₄, LiPF₆, LiAsF₆, LiCF₃SO₃, LiBOB (Lithium Bis (Oxalato) Borate), LiN(SO₂CF₃)₂, and the like are preferable because they are easily dissolved in a solvent.

The nonaqueous electrolytic solution 5 may further contain a vinyl group-containing cyclic siloxane such as 2,4,6,8-tetravinyl-2,4,6,8-tetramethylcyclotetrasiloxane (4VC4S) as an additive.

The nonaqueous electrolytic solution 5 may be contained in the positive electrode 2, the negative electrode 3, and the separator 6 in advance, or may be added after the separator 6 disposed between a side of the positive electrode 2 and a side of the negative electrode 3 is wound or laminated.

### <Separator 6>

The separator 6 may have any structure that is provided between the positive electrode 2 and the negative electrode 3, is insulating, and can contain the nonaqueous electrolytic solution 5.

Examples of the separator 6 include nylon, cellulose, polysulfone, polyethylene, polypropylene, polybutene, polyacrylonitrile, polyimide, polyamide, polyethylene terephthalate, and woven fabrics, nonwoven fabrics, and microporous membranes obtained by combining two or more of them.

The separator 6 may contain various plasticizers, antioxidants, and flame retardants, or may be coated with a metal oxide or the like.

Subsequently, a manufacturing method for the lithium ion secondary battery 1 of the present embodiment will be described.

The manufacturing method for the lithium ion secondary battery 1 of the present embodiment is mainly configured by an active substance forming step of forming the positive electrode composite active substance 20, a positive electrode forming step of forming the positive electrode 2, a negative electrode forming step of forming the negative electrode 3, and a secondary battery assembling step of assembling the positive electrode 2, the negative electrode 3, and the nonaqueous electrolytic solution 5, and the negative electrode forming step and the secondary battery assembling step are the same as the conventional steps, and thus the description thereof is omitted.

In the active substance forming step, first, the lithium ion conductive oxide is pulverized by a pulverizer such as a ball mill to form lithium ion conductive oxide particles (pulverization step).

At this time, the lithium ion conductive oxide is a lithium ion conductive oxide containing phosphorus similar to the coating layer 31 described above, and can be selected from the same material as the coating layer 31 described above.

At this time, the lithium ion conductive oxide before the pulverization step is phosphate-based compound particles having an olivine type crystal structure, and the lithium ion conductive oxide particles after the pulverization are partially broken in crystal structure to be entirely or partially amorphous.

In the present embodiment, when the lithium ion conductive oxide particles are measured by an X-ray diffraction (XRD) method, a unique crystal peak of the lithium ion conductive oxide particles that appeared before pulverization is not confirmed by the halo pattern.

At this time, the lithium ion conductive oxide particles preferably have a BET specific surface area of 20 m²/g or more and 80 m²/g or less.

The lithium ion conductive oxide particles preferably have a BET specific surface area equivalent diameter (dBET) of 30 nm or more, and more preferably 50 nm or more.

Furthermore, the lithium ion conductive oxide particles preferably have a BET specific surface area equivalent diameter (dBET) of 500 nm or less, more preferably 450 nm or less.

Within these ranges, the surface of the oxide active substance 30 can be uniformly coated, and the dense coating layer 31 can be formed.

Note that the BET specific surface area equivalent diameter (dBET) is a particle size by obtaining a nitrogen adsorption BET specific surface area by a nitrogen adsorption method single point method according to a method specified in JIS Z8830(2013), and determined by a formula of dBET=6/(density×BET specific surface area).

Subsequently, the lithium ion conductive oxide particles (phosphate-based compound particles) pulverized and micronized in the pulverization step are dispersed in a dispersion solvent to form a fine particle fluid (fine particle fluid forming step).

The dispersion solvent used at this time is preferably one or more alcohol solutions, and more preferably ethanol from the viewpoint of volatility and safety.

The fine particle fluid formed at this time is a transparent sol in a sol state and is an electrolyte sol having fluidity.

Subsequently, the coating layer 31 is formed on the surface of the oxide active substance 30 by a mechanical coating method in which the oxide active substance 30 and the lithium ion conductive oxide in the fine particle fluid are brought into mechanical contact with each other while applying at least one energy of a shear force, a compressive force, a collision force, and a centrifugal force to the oxide active substance 30 and/or the lithium ion conductive oxide constituting the coating layer 31.

In the present embodiment, the fine particle fluid is ground into the oxide active substance 30 by a grinding device such as a grinding mill to form a ground product (a ground product forming step).

The treatment temperature in the grinding device at this time is preferably 5° C. or higher, more preferably 8° C. or higher, and still more preferably 10° C. or higher.

A treatment temperature in the grinding device at this time is preferably 120° C. or lower, more preferably 100° C. or lower, still more preferably 80° C. or lower, still more preferably 70° C. or lower, and particularly preferably 50° C. or lower.

The treatment time in the grinding device at this time is preferably 5 minutes or more, and more preferably 10 minutes or more.

The treatment time in the grinding device at this time is preferably 90 minutes or less, and more preferably 60 minutes or less.

An atmosphere in the grinding device at this time is preferably an inert gas atmosphere or an air atmosphere.

Subsequently, the ground product is subjected to a heat treatment to remove the dispersion solvent from the ground product, thereby forming the positive electrode composite active substance 20 (removal step).

A heat treatment temperature at this time is preferably higher than 50° C., more preferably 100° C. or higher, still more preferably 300° C. or higher, and particularly preferably 350° C. or higher.

When the heat treatment temperature is lower than 50° C., the adhesion between the oxide active substance 30 and the coating layer 31 becomes insufficient, and the coating layer 31 may be peeled off during charging and discharging of the battery, leading to deterioration of long-term reliability of the battery.

On the other hand, when the heat treatment temperature becomes too high, the crystal structure of the coating layer 31 changes, and the Li ion conductivity decreases, so that the charging and discharging of the battery may not be performed normally. Therefore, the heat treatment temperature is preferably lower than 600° C., and more preferably 500° C. or lower from the viewpoint of suppressing crystallization of the coating layer 31.

The heat treatment time is preferably 30 minutes or more, and more preferably 1 hour or more. An upper limit of the heat treatment time is not particularly limited, but is, for example, 3 hours or less.

The above is the active substance forming step.

When the active substance forming step is completed, the process proceeds to the positive electrode forming step.

In the positive electrode forming step, first, the positive electrode composite active substance 20 obtained in the active substance forming step is mixed with a conductive aid and a binder to prepare a positive electrode mixture, and the positive electrode mixture is applied to the positive electrode current collector 10 (positive electrode applying step).

Subsequently, the positive electrode current collector 10 coated with the positive electrode mixture is dried to form the positive electrode 2 (positive electrode drying step).

The above is the positive electrode forming step.

The positive electrode 2 formed in the positive electrode forming step described above is assembled together with the negative electrode 3 formed in the negative electrode forming step and the nonaqueous electrolytic solution 5 in the same manner as in the prior art, thereby completing the lithium ion secondary battery 1.

According to the positive electrode composite active substance 20 of the present embodiment, since the coating layer 31 uniformly covers the oxide active substance 30, an area in contact with the nonaqueous electrolytic solution 5 is reduced, and gas generation can be suppressed. Furthermore, even in a case where the nonaqueous electrolytic solution 5 or the additive is partially decomposed, the decomposition product can fill a gap of the coating of the coating layer 31 and form a good coating film, so that further decomposition of the nonaqueous electrolytic solution 5 can be suppressed.

According to the positive electrode composite active substance 20 of the present embodiment, the oxide active substance 30 is composed of a lithium manganese-based oxide having a spinel-type crystal structure, and the coating layer 31 is composed of a phosphate-based compound that can be used as a positive electrode active substance. Therefore, the insertion and desorption reaction of lithium ions easily occurs smoothly.

According to the positive electrode composite active substance 20 of the present embodiment, since the vicinity of the interface of the coating layer 31 with the oxide active substance 30 is amorphous, an amorphous portion of the coating layer 31 functions as a buffer even when a volume of the oxide active substance 30 is changed with the progress of charging and discharging. Therefore, cracking and peeling of the coating layer 31 hardly occur.

According to the positive electrode composite active substance 20 of the present embodiment, since the fine particle fluid in which the lithium ion conductive oxide particles are dispersed in the dispersion solvent is ground into the oxide active substance 30 and subjected to a heat treatment at a temperature of 100° C. or more and 500° C. or less, the coating layer 31 having high quality and being thin can be formed on the surface of the oxide active substance 30 while maintaining the amorphous state.

In the embodiment described above, each component member can be freely replaced or added between the embodiments as long as it is included in the technical scope of the present invention.

### EXAMPLES

Hereinafter, the present invention will be specifically described with reference to Examples. Note that the present invention is not limited to the following Examples, and can be appropriately modified without changing the gist thereof.

### Example 1

### (i) Production of Positive Electrode

First, a predetermined amount of ethanol as a solvent was mixed with a lithium iron phosphate (LiFePO₄, hereinafter also referred to as LFP) powder having a surface area of 9.5 m²/g and a median diameter of 1.5 μm, and a planetary ball mill treatment was performed for 3 hours using zirconia spheres having a diameter of 0.5 mm. The zirconia spheres were removed from the treated mixture with a sieve and then dried at 120° C. to remove ethanol. This gave an LFP fine powder having a BET value (BET surface area) of 20 m²/g to 80 m²/g. Next, the LFP fine powder and ethanol were mixed to obtain a slurry (fine particle fluid) in which the LFP fine powder was dispersed in ethanol having a solid content of 16.4 wt %.

As an active substance of the positive electrode, spinel-type lithium nickel manganate (LiNi_{0.5}Mn_{1.5}O₄, hereinafter, also referred to as LNMO) having a median diameter of 5 μm was used.

30 g of LNMO was charged into a grinding mill (manufactured by Hosokawa Micron Corporation, product name: NOBILTA), and while rotating the mill at a clearance of 0.6 mm, a rotor load power of 1.5 kW, and 2,600 rpm, the ethanol-dispersed slurry of the LFP fine powder was charged in two batches so that the added amount of the LFP fine powder was 4.5 g (corresponding to 2.4 wt %). Thereafter, the rotor rotation speed was maintained in a range of 2,600 rpm to 3,000 rpm, and treatment was performed at room temperature for 10 minutes under an air atmosphere to obtain LNMO (Hereinafter, also referred to as surface-coated LNMO) with the surface coated with LFP. The obtained surface-coated LNMO was heat-treated at 350° C. for 1 hour to obtain a positive electrode composite active substance.

A mixture containing the obtained positive electrode composite active substance, acetylene black as a conductive aid, and polyvinylidene fluoride (PVdF) as a binder in an amount of 90 parts by weight, 6 parts by weight, and 4 parts by weight, respectively, in terms of solid concentration was prepared, and a slurry in which the mixture was dispersed in N-methyl-2-pyrrolidone (NMP) was produced. Note that the binder was adjusted to an N-methyl-2-pyrrolidone (NMP) solution having a solid concentration of 5% by weight, and NMP was further added to adjust the viscosity so as to facilitate the coating described later.

The slurry was applied to a 20 μm aluminum foil, and then dried in an oven at 120° C. This operation was performed on both surfaces of the aluminum foil, and the aluminum foil was further vacuum-dried at 170° C. to produce a positive electrode.

### (ii) Production of Negative Electrode

As a negative electrode active substance, spinel-type lithium titanate (Li₄Ti₅O₁₂, hereinafter, also referred to as LTO) was used. A mixture containing 100 parts by weight, 5 parts by weight, and 5 parts by weight, respectively, of the LTO, acetylene black as a conductive aid material, and polyvinylidene fluoride (PVdF) as a binder in terms of solid concentration was prepared, and a slurry in which the mixture was dispersed in N-methyl-2-pyrrolidone (NMP) was produced. Note that, as the binder, a binder prepared in an NMP solution having a solid content concentration of 5% by weight was used, and NMP was further added to adjust the viscosity so as to facilitate the coating described later.

The slurry was applied to a 20 μm aluminum foil, and then dried in an oven at 120° C. This operation was performed on both surfaces of the aluminum foil, and then vacuum drying was further performed at 170° C. to produce a negative electrode.

(iii) Production of Lithium Ion Secondary Battery

A battery was produced by the following procedure using the positive electrode and the negative electrode produced in the above (i) and (ii) and a 20 μm polypropylene separator.

First, the positive electrode and the negative electrode were dried under reduced pressure at 80° C. for 12 hours. Next, 15 positive electrodes and 16 negative electrodes were used and laminated in the order of negative electrode/separator/positive electrode. Both outermost layers were made to be separators. Next, aluminum tabs were vibration-welded to the positive electrode and the negative electrode at both ends.

Two aluminum laminate films as exterior materials were prepared, and after forming a depression to be a battery part and a depression to be a gas collecting part by pressing, the electrode laminate was placed.

An outer peripheral portion leaving a space for injecting a nonaqueous electrolyte solution was heat-sealed at 180° C. for 7 seconds, LiPF₆ was dissolved at a rate of 1 mol/L in a solvent obtained by mixing ethylene carbonate, propylene carbonate, and ethyl methyl carbonate at a ratio of ethylene carbonate/propylene carbonate/ethyl methyl carbonate=15/15/70 on a volume basis from an unsealed portion, the nonaqueous electrolyte was added, and then the unsealed portion was heat-sealed at 180° C. for 7 seconds while reducing the pressure.

The obtained battery was subjected to constant current charging at a current value corresponding to 0.2 C until the battery voltage reached an end voltage of 3.4 V, and charging was stopped. Thereafter, the battery was allowed to stand in an environment of 60° C. for 24 hours, and then discharged at a constant current at a current value corresponding to 0.2 C, and the discharge was stopped when the battery voltage reached 2.5 V. After the discharge was stopped, the gas accumulated in the gas collecting part was removed, and resealing was performed. A lithium ion secondary battery for evaluation was produced by the above operation.

### Example 2

This example was designated as Example 2 in the same manner as “(i) Production of positive electrode” in Example 1 except that the coating amount of the LFP fine powder was adjusted to 6.9 g (corresponding to 3.6 wt %) in the production of the positive electrode.

### Comparative Example 1

According to “(i) Production of positive electrode,” Li_{1.3}Al_{0.3}Ti_{1.7}(PO₄)₃ (hereinafter, also referred to as LATP) was prepared as an active substance of the positive electrode by the following method.

As starting materials, Li₂CO₃, AlPO₄, TiO₂, NH₄H₂PO₄, and ethanol as a solvent were mixed in predetermined amounts, and a planetary ball mill treatment was performed at 150 G for 1 hour using zirconia balls having a diameter of 3 mm. The zirconia spheres were removed from the treated mixture with a sieve and then dried at 120° C. to remove ethanol. Thereafter, treatment was performed at 800° C. for 2 hours to obtain a LATP powder.

Except that the LATP powder described above was used, the same procedure as in Example 1 was carried out to prepare Comparative Example 1.

### Comparative Example 2

A positive electrode was produced in the same manner as “(i) Production of positive electrode” in Comparative Example 1 except that the coating amount of the LATP fine powder was adjusted to 6.9 g (corresponding to 3.6 wt %), and this was designated as Comparative Example 2.

### Comparative Example 3

This was designated as Comparative Example 3 in the same manner as “(i) Production of positive electrode” in Example 1, except that LNMO without surface coating was used in the production of the positive electrode.

### Comparative Example 4

This example was designated as Comparative Example 4 in the same manner as “(i) Production of positive electrode” in Example 1 except that the surface-coated LNMO was heat-treated at 600° C. for 1 hour in the production of the positive electrode.

### Comparative Example 5

This example was designated as Comparative Example 5 in the same manner as “(i) Production of positive electrode” in Example 1 except that the surface-coated LNMO was heat-treated at 50° C. for 1 hour in the production of the positive electrode.

### Comparative Example 6

This example was designated as Comparative Example 6 in the same manner as “(i) Production of positive electrode” in Example 1 except that in the production of the positive electrode, a predetermined amount of ethanol as a solvent was mixed with a lithium iron phosphate powder, and a planetary ball mill treatment was performed for 0.5 hours.

### Comparative Example 7

According to “(i) Production of positive electrode,” the LFP fine powder was dispersed in ethanol, LNMO was added with stirring so that the weight of the LFP fine powder was 3%, and stirring was continued for 1 hour. Thereafter, ethanol was removed by reduced pressure, and then heating was performed at 120° C. to further remove ethanol, thereby obtaining LNMO surface-coated with LFP. The resulting surface-coated LNMO was heat-treated at 350° C. for 1 hour. Except that a positive electrode was prepared using the surface-coated LNMO, the same procedure as in Example 1 was carried out to prepare Comparative Example 7.

### (Measurement of Gas Generation Amount)

The evaluation of the gas generation amount of the lithium ion secondary battery before and after the cycle characteristics evaluation in each of Examples 1 and 2 and Comparative Examples 1 to 7 was performed using the Archimedes method, that is, the buoyancy of the lithium ion secondary battery. The gas generation amount was evaluated as follows.

First, the weight of the lithium ion secondary battery was measured with an electronic balance. Next, the weight in water was measured using a pycnometer (manufactured by Alpha Mirage Co., Ltd., product number: MDS-3000), and the buoyancy was calculated by taking a difference between these weights. A volume of the lithium ion secondary battery was calculated by dividing the buoyancy by the density of water (1.0 g/cm³). The amount of gas generated was calculated by comparing the volume after aging (that is, the volume after charging by applying a voltage and then discharging) with the volume after the following cycle characteristics evaluation. A gas generation amount of 5 ml or less was determined to be good.

### (Evaluation of Cycle Characteristics of Lithium Ion Secondary Battery)

The lithium ion secondary battery produced in each of Examples 1 and 2 and Comparative Examples 1 to 7 was connected to a charging and discharging device (HJ1005SD8, manufactured by HOKUTO DENKO CORPORATION), and a cycle operation was performed. Under an environment of 60° C., constant current charging was performed at a current value corresponding to 1.0 C until the battery voltage reached a final voltage of 3.4 V, and charging was stopped. Subsequently, constant current discharge was performed at a current value corresponding to 1.0 C, and the discharge was stopped when the battery voltage reached 2.5 V. Charging and discharging were repeated with this as one cycle. The stability of the cycle characteristics was evaluated with the 500th discharge capacity when the first discharge capacity was set to 100 as a discharge capacity retention rate (%). A discharge capacity retention ratio at the 500th time of 90% or more was regarded as good, and a discharge capacity retention rate at the 500th time of less than 90% was regarded as poor.

### (Scanning Transmission Electron Microscope Observation)

The positive electrode composite active substance was embedded in a resin, sandwiched between silicon wafers, then sectioned with an ion milling device (Model 691 manufactured by Gatan), and the thinned portion was observed with a scanning transmission electron microscope (manufactured by Hitachi High-Tech Corporation, HD-2700).

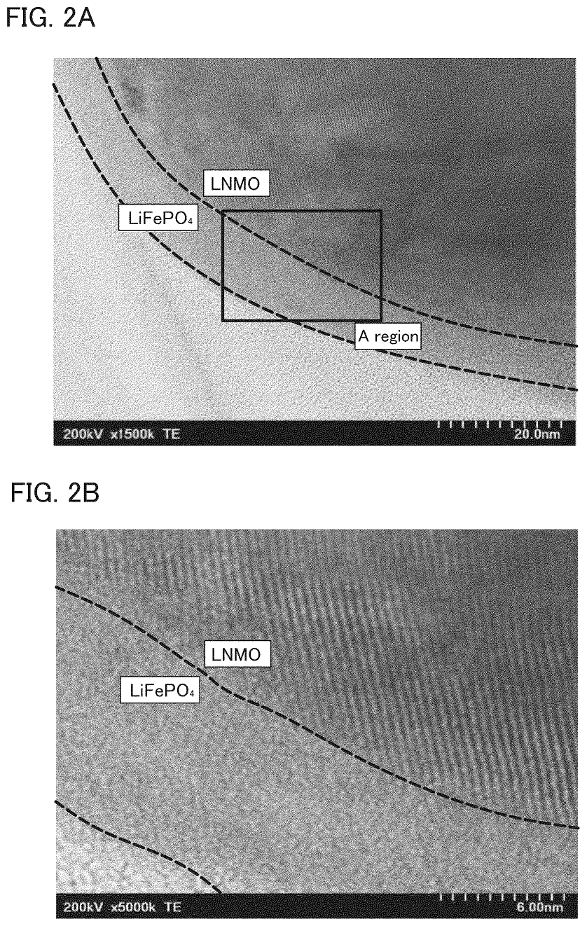

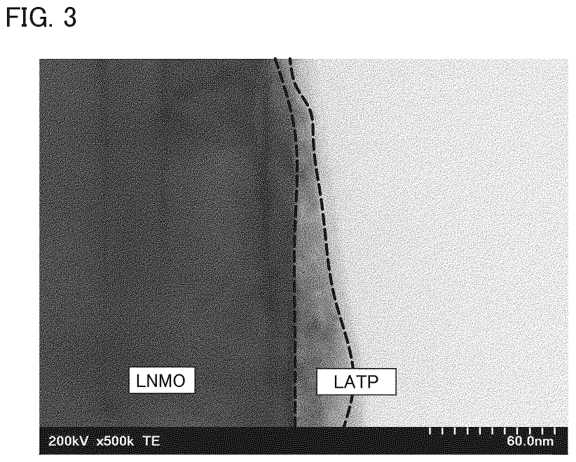

The evaluation results of Examples 1 and 2 and Comparative Examples 1 to 3 are shown in Table 1, and the evaluation results of Example 1 and Comparative Examples 4 to 7 are shown in Table 2. Furthermore, a scanning transmission electron microscope image of Example 1 is illustrated in FIG. 2, and a scanning transmission electron microscope image of Comparative Example 1 is illustrated in FIG. 3.

TABLE 1
Table 1

| | | | PARTICLE | THICKNESS | | CYCLE |
|---|---|---|---|---|---|---|
| | | FINE | SIZE | OF | GAS | CHARACTERISTICS |
| | TYPE OF | PARTICLE | BEFORE | COATING | GENERATION | (CAPACITY |
| | COATING | AMOUNT | GRINDING | LAYER | AMOUNT | RETENTION |
| | LAYER | (wt %) | (nm) | (nm) | (ml) | RATE) (%) |
| EXAMPLE 1 | LFP | 2.4 | 70 | 5~15 | 5 | 91 |
| EXAMPLE 2 | LFP | 3.6 | 430 | 5~20 | 3 | 93 |
| COMPARATIVE | LATP | 2.4 | 3 | 5~15 | 8 | 91 |
| EXAMPLE 1 | | | | | | |
| COMPARATIVE | LATP | 3.6 | 5 | 5~10 | 9 | 90 |
| EXAMPLE 2 | | | | | | |
| COMPARATIVE | — | — | — | — | 40 | 60 |
| EXAMPLE 3 | | | | | | |

TABLE 2
Table 2

| | | PARTICLE | | | CYCLE |
|---|---|---|---|---|---|
| | | SIZE | HEAT | GAS | CHARACTERISTICS |
| | | BEFORE | TREATMENT | GENERATION | (CAPACITY |
| | COATING | GRINDING | TEMPERATURE | AMOUNT | RETENTION |
| | METHOD | (nm) | (° C.) | (ml) | RATE) (%) |
| EXAMPLE 1 | MECHANICAL | 70 | 350 | 5 | 91 |
| | COATING | | | | |
| COMPARATIVE | MECHANICAL | 220 | 600 | 35 | 71 |
| EXAMPLE 4 | COATING | | | | |
| COMPARATIVE | MECHANICAL | 260 | 50 | 25 | 87 |
| EXAMPLE 5 | COATING | | | | |
| COMPARATIVE | MECHANICAL | 510 | 350 | 28 | 85 |
| EXAMPLE 6 | COATING | | | | |
| COMPARATIVE | EVAPORATION | 210 | 350 | 34 | 75 |
| EXAMPLE 7 | TO DRYNESS | | | | |

As shown in Table 1, in Examples 1 and 2 in which LFP was used as the coating layer, the capacity retention rate was almost the same as that in Comparative Examples 1 and 2 in which LATP was used as the coating layer, and the gas generation amount was small.

Furthermore, in Comparative Examples 1 and 2 in which LATP was used as the coating layer, the thickness of the coating layer was thicker than the particle size before grinding, whereas in Examples 1 and 2 in which LFP was used as the coating layer, the thickness of the coating layer was thinner than the particle size before grinding.

In Examples 1 and 2 in which LFP was coated on LNMO, the gas generation amount was smaller than that in Comparative Example 3 in which LFP was not coated on LNMO, and the capacity retention rate was higher.

In Examples 1 and 2, as shown in Tables 1 and 2, the gas generation amount was 10 ml or less and the capacity retention rate was 90% or more, and the gas generation amount was smaller and the capacity retention rate was higher as compared with other Comparative Examples 4 to 7 coated with LFP.

In Example 1 in which the heat treatment temperature was 350° C., the amount of generated gas was smaller and the capacity retention rate was also higher as compared with Comparative Example 4 in which the heat treatment temperature was 600° C. and Comparative Example 5 in which the heat treatment temperature was 50° C.

This result suggests that the heat treatment temperature is preferably in a range of more than 50° C. and less than 600° C., and more preferably 100° C. or more and 500° C. or less from the viewpoint of suppressing the amount of gas generated and improving the capacity retention rate.

In Example 1, the amount of generated gas was small and the capacity retention rate was also high as compared with Comparative Example 6 in which the pulverization time in the pulverization step was short and the particle size was large. That is, in Example 1 having a large BET surface area, the amount of generated gas was small and the capacity retention rate was high as compared with Comparative Example 6 having a small BET surface area.

From this result, it was suggested that the amount of generated gas can be reduced and the capacity retention rate can be increased by reducing the particle size of the LFP fine powder and increasing the surface area.

In Example 1 in which LFP was coated by mechanical coating, the amount of generated gas was smaller and the capacity retention rate was also higher as compared with Comparative Example 7 in which LFP was coated by evaporation to dryness.

From this result, it was suggested that the amount of generated gas can be reduced and the capacity retention rate can be improved by coating LFP with mechanical coating.

In Example 1, as shown in FIG. 2A, a continuous layer of LFP of 5 nm to 15 nm was confirmed on the surface of the LNMO. That is, the coating layer of Example 1 was a thin and uniform layer, and a difference between the maximum thickness and the minimum thickness was 15 nm or less.

In LNMO, regular lattice fringes were confirmed as shown in FIG. 2B, suggesting that a spinel-type crystal structure was maintained. On the other hand, lattice fringes were not confirmed throughout the LFP, suggesting that the LFP is amorphous at least in the range of 2 nm from the interface with LNMO.

Furthermore, the coating layer of Comparative Example 1 had an irregular shape with different thicknesses depending on positions as shown in FIG. 3, whereas the coating layer of Example 1 was a thin and uniform layer as shown in FIG. 2A.

This suggests that a thin and uniform layer can be formed by forming the coating layer with LFP.

The above results are summarized as follows.
(1) It was found that by coating the surface of LNMO with LFP, the gas generation amount can be suppressed as compared with the case of coating with LATP.
(2) It was found that, by grinding the LFP, the thickness of the coating layer formed by grinding becomes smaller than the particle size of the LFP before grinding.
(3) It was found that the suppression of the gas generation amount and the improvement of the capacity retention rate can be expected by adjusting the heat treatment temperature.
(4) It was found that the suppression of the gas generation amount and the improvement of the capacity retention rate can be expected by performing a mechanical coating method, particularly grinding.
(5) It was found that the suppression of the gas generation amount and the improvement of the capacity retention rate can be expected by making the vicinity of the interface between LFP and LNMO amorphous.
(6) It was found that even when the thickness of LFP was about 5 nm to 20 nm, the gas generation amount could be sufficiently suppressed, and a sufficient capacity retention ratio could be secured.
(7) It was suggested that a thin and uniform layer was formed by using LFP as the coating layer.

### REFERENCE CHARACTER LIST

1: Lithium ion secondary battery
2: Positive electrode
3: Negative electrode
5: Nonaqueous electrolytic solution
10: Positive electrode current collector
11: Positive electrode composite active substance layer
20: Positive electrode composite active substance
21: Negative electrode active substance
30: Oxide active substance
31: Coating layer

1. A positive electrode composite active substance constituting a part of a positive electrode of a lithium ion secondary battery using a nonaqueous electrolytic solution as an electrolyte, the positive electrode composite active substance comprising:
an oxide active substance; and
a coating layer covering a surface of the oxide active substance, wherein
the oxide active substance includes a lithium manganese-based oxide having a spinel-type crystal structure,
the coating layer includes a phosphate-based compound represented by Formula (1) described below, and
the coating layer has a thickness of 5 nm or more and 20 nm or less,
LiₐA_{b}D_{c}PO₄ (1)
where a, b, and c satisfy 0.9<a<1.1, 0<b≤1, 0≤c<1, 0.9<b+c<1.1, A is at least one selected from the group consisting of Co, Mn, Ni, Fe, Cu, and Cr, and D is at least one selected from the group consisting of Mg, Ca, Sr, Ba, Ti, Zn, B, Al, Ga, In, Si, Ge, Sc, and Y.

2. The positive electrode composite active substance according to claim 1, wherein the coating layer is amorphous in a range of 2 nm from an interface with the oxide active substance.

3. The positive electrode composite active substance according to claim 1 or 2, wherein the oxide active substance is a compound represented by Formula (2) described below,
Li₁₊ₓM_{y}Mn_{2-x-y}O₄ (2)
where x and y satisfy 0≤x≤0.2 and 0<y≤0.8, respectively, and M is at least one selected from the group consisting of Al, Mg, Zn, Ni, Co, Fe, Ti, Cu, and Cr.

4. A method of manufacturing a positive electrode composite active substance that constitutes a portion of a positive electrode of a lithium ion secondary battery using a nonaqueous electrolytic solution as an electrolyte, and includes an oxide active substance and a coating layer covering a surface of the oxide active substance, the method comprising:
a fine particle fluid forming step of dispersing phosphate-based compound particles in a dispersion solvent to form a fine particle fluid;
a ground product forming step of grinding the fine particle fluid into an oxide active substance to form a ground product; and
a removal step of subjecting the ground product to a heat treatment and removing the dispersion solvent to form the coating layer, wherein
the phosphate-based compound particles have an average particle size larger than or equal to a thickness of the coating layer, and include a phosphate-based compound represented by Formula (1) described below,
LiₐA_{b}D_{c}PO₄ (1)
where a, b, and c satisfy 0.9<a<1.1, 0<b≤1, 0≤c<1, 0.9<b+c<1.1, A is at least one selected from the group consisting of Co, Mn, Ni, Fe, Cu, and Cr, and D is at least one selected from the group consisting of Mg, Ca, Sr, Ba, Ti, Zn, B, Al, Ga, In, Si, Ge, Sc, and Y.

5. The method of manufacturing a positive electrode composite active substance according to claim 4, further comprising a pulverization step of pulverizing a phosphate-based compound having an olivine type crystal structure to form the phosphate-based compound particles before the fine particle fluid forming step.

6. The method of manufacturing a positive electrode composite active substance according to claim 4 or 5, wherein the phosphate-based compound particles have an average particle size of 30 nm or more and 500 nm or less.

7. The method of manufacturing a positive electrode composite active substance according to any one of claims 4 to 6, wherein the coating layer has a thickness of 5 nm or more and 20 nm or less.

8. The method of manufacturing a positive electrode composite active substance according to any one of claims 4 to 7, wherein in the removal step, the ground product is heat-treated at a temperature of 100° C. or more and 500° C. or less to remove the dispersion solvent.
